(19) United States
(12) Patent Application Publication
(10) Pub. No.: US 2024/0412209 A1
(43) Pub. Date: Dec. 12, 2024

(54) SYSTEMS AND METHODS FOR DYNAMIC DECLINATION GENERATION

(71) Applicant: Capital One Services, LLC, McLean, VA (US)

(72) Inventor: Narahari Shettyhalli Shankarnarayana, Henrico, VA (US)

(21) Appl. No.: 18/331,101

(22) Filed: Jun. 7, 2023

(51) Int. Cl. G06Q 20/40; G06Q 20/34

(52) U.S. Cl. CPC G06Q 20/401; G06Q 20/351

(57) ABSTRACT

Disclosed embodiments may include a system for dynamic declination generation. The system may receive authentication data associated with an account from a user device. The system may authenticate the user device by comparing the authentication data to account data. The system may generate a declination statement comprising virtual card information and one or more declinations associated with the account. The system may generate a graphical user interface (GUI) comprising the declination statement. The system may transmit the GUI to the user device for display. The system may receive one or more new declinations associated with the account from a network. In response to receiving one or more new declinations associated with the account, the system may modify the GUI to further comprise the one or more new declinations.

The disclosed technology relates to systems and methods for dynamic declination generation. Specifically, this disclosed technology relates to systems and methods for dynamically providing a declination statement via a graphical user interface (GUI).

### BACKGROUND

A primary account number (PAN) can be tokenized to one or more virtual card numbers (VCNs) that can be used to make purchases over specific time frames (e.g., one-time use) or at specific locations (e.g., at a specified online merchant). The use of VCNs can be helpful in reducing fraud in the event of a security breach because the controls placed on VCNs will prevent their use in unauthorized manners. If a VCN is used in an unauthorized manner (e.g., being used to attempt a purchase at an unauthorized merchant), then the attempted transaction will be declined by the payment processing system. However, there may be circumstances where a VCN is declined for a transaction that is otherwise legitimate. For example, if a VCN is created for use at a particular merchant website but the user accidentally uses it at a different merchant website. Further, VCN's can be stored on a merchant website as a card-on-file for use in making future or recurring purchases, however such future/recurring purchases may be declined if the VCN has expired in the interim. In such cases, the user may not be aware of the declination, or even if so, may not know the reason the VCN was declined, which can result in incomplete transactions and difficulties in rectifying declination issues with VCNs.

Accordingly, there is a need for improved systems and methods for dynamic declination generation. Embodiments of the present disclosure are directed to this and other considerations.

### SUMMARY

Disclosed embodiments may include a system for dynamic declination generation. The system may include one or more processors, and memory in communication with the one or more processors and storing instructions that, when executed by the one or more processors, are configured to cause the dynamic declination generation system to provide dynamic declination generation. The system may receive authentication data associated with an account from a user device. The system may authenticate the user device by comparing the authentication data to account data. The system may generate a declination statement comprising virtual card information and one or more declinations associated with the account. The system may generate a graphical user interface (GUI) comprising the declination statement. The system may transmit the GUI to the user device for display. The system may receive one or more new declinations associated with the account from a network. In response to receiving one or more new declinations associated with the account, the system may modify the GUI to further comprise the one or more new declinations.

Disclosed embodiments may include a system for dynamic declination generation. The system may include one or more processors, and memory in communication with the one or more processors and storing instructions that, when executed by the one or more processors, are configured to cause the dynamic declination generation system to provide dynamic declination generation. The system may generate a declination statement comprising virtual card information and one or more declinations associated with an account; generate a graphical user interface (GUI) comprising the declination statement. The system may transmit the GUI to a user device for display. The system may receive one or more new declinations associated with the account, from a network. In response to receiving one or more new declinations associated with the account, the system may modify the GUI to further comprise the one or more new declinations.

Disclosed embodiments may include a system for dynamic declination generation. The system may include one or more processors, and memory in communication with the one or more processors and storing instructions that, when executed by the one or more processors, are configured to cause the dynamic declination generation system to provide dynamic declination generation. The system may receive authentication data associated with an account from a user device. The system may authenticate the user device by comparing the authentication data to account data. The system may generate a declination statement comprising virtual card information and one or more declinations associated with the account. The system may send the declination statement to the user device.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for dynamic declination generation in accordance with certain embodiments of the disclosed technology.

FIG. 2 is a flow diagram illustrating an exemplary method for dynamic declination generation in accordance with certain embodiments of the disclosed technology.

FIG. 3 is block diagram of an example declination generation system used to provide dynamic declination generation, according to an example implementation of the disclosed technology.

FIG. 4 is block diagram of an example system that may be used to provide dynamic declination generation, according to an example implementation of the disclosed technology.

### DETAILED DESCRIPTION

Examples of the present disclosure related to systems and methods for dynamic declination generation. More particularly, the disclosed technology relates to generating a declination statement associated with one or more virtual cards that are associated with an account and dynamically presenting the declination statement to the user so that the user may view and/or take some action in relation to one or more declinations/virtual cards. The systems and methods described herein utilize, in some instances, graphical user interfaces (GUIs), which are necessarily rooted in computers and technology. Graphical user interfaces are a computer technology that allows for user interaction with computers through touch, pointing devices, or other means. The present disclosure details generating a GUI that may dynamically present the declination statement to the user. This, in some examples, may involve using declination information obtained from payment processing systems to dynamically change the graphical user interface in near real-time so that the GUI may dynamically incorporate new declination information into the GUI for presentation to the user. In some embodiments, the GUI may present a list of declinations that may be configured to be dynamically re-ordered upon receipt of new declination data based on a selected feature. For example, the list of declinations may be ordered based on the amount of the associated transaction, the likelihood that the declination is the result of fraud, the date/time of the declination, by the location/merchant that the attempted transaction was made at, by the virtual card associated with the declined transaction, or other such features that the GUI may be configured to allow a user to select. According to some embodiments, a user device may be authenticated prior to providing access to the GUI, which may involve for example, scanning a quick response (QR) code on a user's account statement and/or providing other user-authenticating information such as a username/password or facial scan of the user, which may involve using a digital camera of the user device along with image recognition technology. Using a graphical user interface as described herein may allow the system to allow a user to view virtual card number declinations, gain an understanding of the reasons the virtual cards were declined, and may provide the user with the ability to take one or more actions related to the virtual card numbers, such as for example, generating a new virtual card number upon discovering that a prior virtual card number had been declined because it was expired. This is a clear advantage and improvement over prior technologies that do not gather declination information from payment processing systems and provide it to the user in a dynamic GUI because users may not realize when a virtual card number has been declined and/or why a virtual card number has been declined. The present disclosure solves this problem by gathering declination information from payment processing systems and presenting it in a dynamic GUI that a user may be able to view, manipulate, and pursue mitigating actions such as cancelling a virtual card number and/or creating a new one. Overall, the systems and methods disclosed have significant practical applications in the payment processing field because of the noteworthy improvements of the dynamic declination system, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

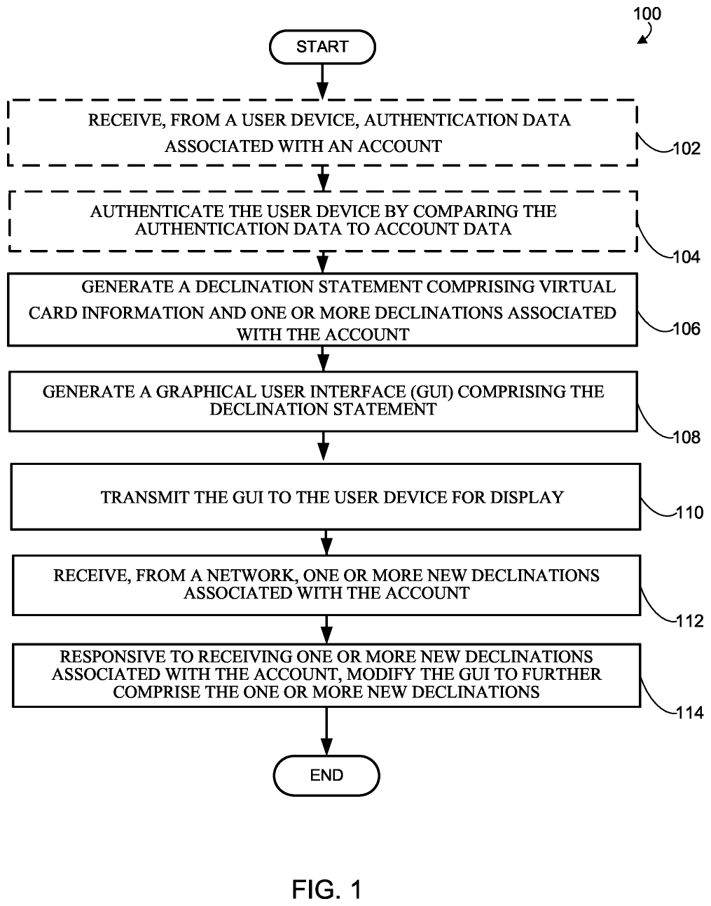

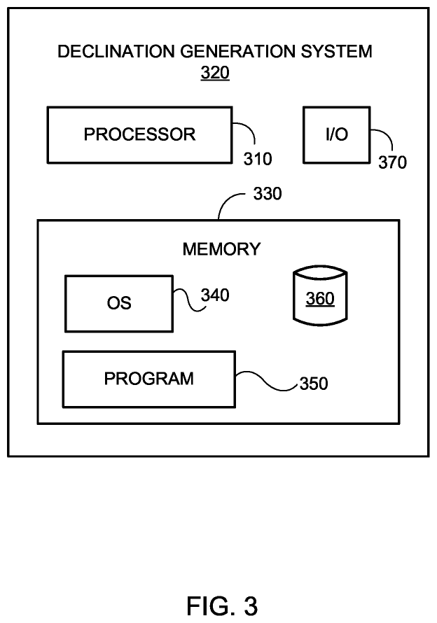

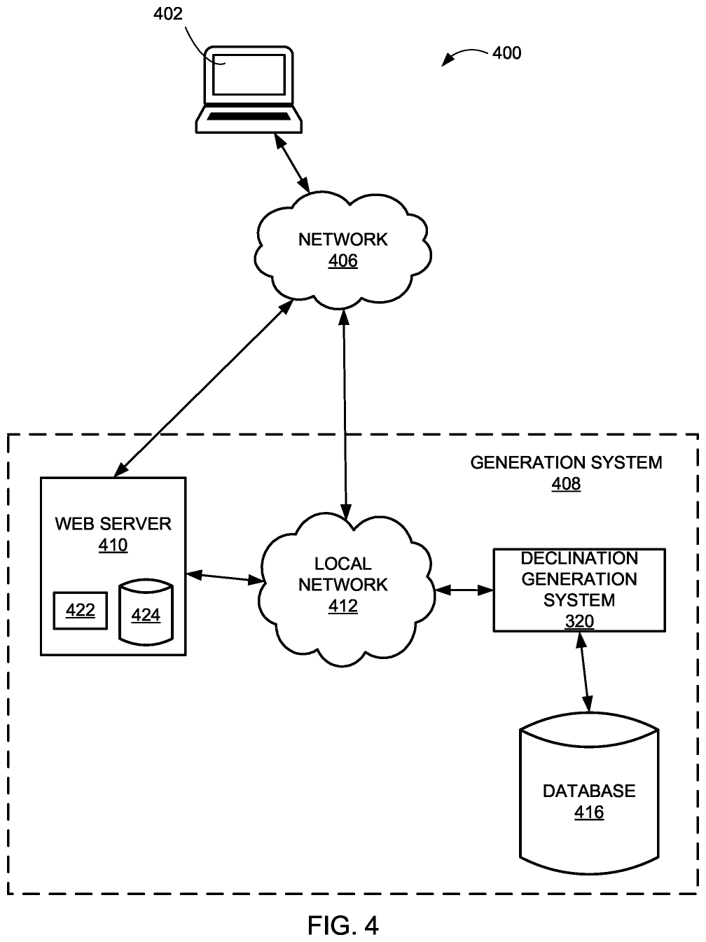

FIG. 1 is a flow diagram illustrating an exemplary method 100 for dynamic declination generation, in accordance with certain embodiments of the disclosed technology. The steps of method 100 may be performed by one or more components of the system 400 (e.g., declination generation system 320 or web server 410 of generation system 408 or user device 402), as described in more detail with respect to FIGS. 3 and 4. It should be understood that certain embodiments of the disclosed technology may omit one or more block as being optional.

In block 102, the declination generation system 320 may receive authentication data associated with an account from a user device 402. According to some embodiments, authentication data may include for example, an account number, a username and password or other account-identifying information, such as a one-time code presented as part of a two-factor authentication process and/or biometric identification data such as a facial scan of the user performed by a smartphone. In some embodiments, the authentication data may be input to or otherwise obtained by a user device 402. For example, a user may input their username, password, and/or one-time code into a mobile application running on a user device 402, such as a smartphone. The mobile application may transmit the authentication data to the declination generation system 320 via network 406.

According to some embodiments, the authentication data associated with the account may be received from the user device 402 via a quick response (QR) code. For example, a QR code may be printed on an account statement that has been mailed to the user and the user may scan/image the QR code using a digital camera of the user's smartphone, which may decode the QR code and provide access to the user's account. According to some embodiments, upon imaging/decoding the QR code, the user device 402 may provide the user with access to account information by, for example, providing a link to a website containing the user's account information, providing a link to a website that allows the user to log into their account or by causing a mobile software application present on the user device 402 (e.g., a mobile banking software application) to automatically open and provide the user with access to account information.

In block 104, the declination generation system 320 may authenticate the user device 402 by comparing the authentication data to account data. For example, the declination generation system 320 may compare the received authentication data to stored authentication data and authenticate the user device 402 if the data matches. According to some embodiments, upon authenticating the user device 402, the declination generation system 320 may communicate the authentication to the user device 402, which may allow the user to access the account (e.g., via a mobile software application) and other account information via the user device 402. For example, the user device 402 may have a mobile banking application that, upon authenticating the user/device, allows the user to log into their bank account and view statements and perform various actions in relation to the bank account.

According to some embodiments, if the authentication data is received from the user device 402 via a QR code, scanning of the QR code by the user device 402 may result in the user device 402 establishing a connection to or otherwise communicating with generation system 408 (e.g., web server 410) to authenticate the user device 402. For example, scanning of the QR code by the user device 402 may cause the user device 402 to open a web browser or activate a mobile software application stored on user device 402 that may allow the user device 402 to connect to or communicate with web server 410 for the purpose of authenticating the user device 402. For example, the web server 410 may authenticate the user device 402 by receiving authentication data such as one or more of an account number, username, password and/or biometric authentication data (e.g., a facial scan of the user using the camera of a smartphone to confirm the user's identity) and determining based on the received authentication data that a user of the user device 402 is authorized to access an account. According to some embodiments, account information may be encoded in the QR code, such that the generation system 408 may compare the account information encoded in the QR code with account information associated with the received authentication data (e.g., username and password) to authenticate the user device 402 when the data corresponds to one another. In some embodiments, the authentication data may include a card's card verification value (CVV), which is commonly a three or four digit number that is printed on a physical card and used for security verifications. For example, in some embodiments, a user may scan a QR code that has their account number encoded in it, and in response to scanning the QR code the user may be prompted (e.g., via a mobile application running on user device 402) to input the CVV value associated with their card and the declination generation system may receive the input CVV value and compare it to a stored CVV value associated with the account number encoded in the QR code to authenticate the user and/or user device 402 as being legitimately associated with the account. According to some embodiments, the declination generation system 320 may store hash values of the account number and CVV numbers and hash the received CVV number for comparison to the stored hashed CVV number. As will be appreciated by those of skill in the art, hashing and storing hashed values of the account and CVV numbers can provide an extra layer of security against such account numbers being compromised by a malicious actor.

According to some embodiments, the QR code may not encode account information but may simply encode a link to a website or instructions to automatically open a mobile software application on the user device 402 and prompt the user to provide authentication data (e.g., username and password) into one or more fields of the website/mobile software application. Upon properly logging into a valid account with the provided authentication data via the user device 402, the generation system 408 may authenticate the user device 402 as being associated with the account.

In block 106, the declination generation system 320 may generate a declination statement including virtual card information and one or more declinations associated with the account. According to some embodiments, the virtual card information may include an account number, a card number, and/or a status of the account. The card number may be a virtual card number that corresponds to the account number, which may be a master account number. In some embodiments, a master account number may be associated with a plurality of different virtual card numbers. Thus, for example, a user may have a single credit card having an account number that serves as the master account number, but a plurality of virtual card numbers may be created based on the master account number. According to some embodiments, the master account number will ultimately be assigned any debits/credits placed against each individual virtual card number. Thus, for example, a user may put charges on five different virtual card numbers, but those charges will be ultimately assigned to the master account number. In other words, the user may use five different virtual card numbers, but all of the charges made by these virtual cards will ultimately show up on a single bill associated with their master account number (e.g., their credit card). In some embodiments, each virtual card number may have associated rules that place restrictions on its use, such as for example, restricting its use to one or more specified merchants (e.g., based on the merchant and/or merchant category code as provided by a payment processing system), restricting its use to one or more specified timeframes (e.g., certain times of day, certain days of the week and/or for a particular duration until expiry), restricting its use to a predetermined number of uses (e.g., it can only be used three times and then it expires) and/or restricting its use to purchases below a specified purchase limit (e.g., no purchases of more than $500, either individually or in the aggregate). According to some embodiments, the status of the account may provide an indication of one or more statuses of the account, such as for example, whether the account is active, whether the account has expired, whether the account has been frozen for security reasons, whether the account has an overdue balance, or any other such status information regarding an account. In some embodiments, one or more declination statements can be organized as monthly statements in a manner similar to how charges are typically organized on monthly credit card bills. In some embodiments, the declination statement can include declination information for declined transactions that occurred during a date range that is specified by the user.

According to some embodiments, the one or more declinations may include restriction details, a declination code and a declination explanation. According to some embodiments, restriction details may include rules or restrictions placed on a virtual card number associated with an account. For example, restriction details may list one or more merchants at which a virtual card number is authorized to be used, may list one or more timeframes during which a virtual card number is authorized to be used, a spending limit associated with a virtual card number, a number of times the virtual card may be authorized to be used before expiring or any other such restrictions as may be placed on the use of a particular virtual card number that is associated with an account. In some embodiments, restriction details of one or more virtual card numbers associated with an account may be stored by the generation system 408 in association with a user's account. According to some embodiments, a declination code may be a code that is used by and received from a payment processing system/platform (such as, for example, TSYS) that processes payments when a card, such as a credit card or virtual card number, is used to attempt to make a purchase at a merchant. As will be understood by those of skill in the art, when an account number, such as a credit card number, is used to attempt to make a purchase, a payment processing system may perform backend processing to determine whether the transaction will be approved and allowed to proceed or not. If the payment processing system declines the use of an account to complete a purchase, the system may generate data associated with the attempted purchase that may include the identity of the merchant at which the transaction was attempted (e.g., represented by a merchant name code and/or merchant category code), the amount of the attempted transaction, a timestamp of the attempted transaction, and when declined, a declination code indicating a reason why the transaction was declined in association with the account number (e.g., virtual card number). According to some embodiments, a declination explanation may be a written explanation of why the card was declined, such as for example, “card expired”, “card used at unauthorized merchant”, “attempted purchase exceeded card spending limit”, “card used at unauthorized time” or “account has been frozen for security reasons”. According to some embodiments, the declination generation system 320 may generate a declination explanation by utilizing one or more application programming interfaces (APIs) that can populate the description provided in the declination explanation with the merchant name, virtual card number and linked-card details (e.g., a master card that the virtual card number is linked to) by pulling this information from transaction data provided by the payment processing system. In some embodiments, the declination generation system 320 may generate a written description of a reason for the declination based on the declination code provided by the payment processing system when the transaction is declined. Thus, in this way, the declination statement may provide a user with a listing of declinations that have occurred in association with one or more accounts and/or virtual card numbers and allow the user to understand the reason a particular account/card was declined at a particular time.

In block 108, the declination generation system 320 may generate a graphical user interface (GUI) including the declination statement. The GUI may include a listing of all declinations during a specified time period for one or more accounts and/or virtual card numbers. The GUI may be dynamic such that it may automatically update as new declinations are received. According to some embodiments, the GUI may be dynamic in that it may rearrange a list of declinations based on one or more factors such as, timestamp, location, number of declinations associated with each virtual card number, or amount of the attempted transaction. In some embodiments, the GUI may be configured to automatically rearrange the list based on a particular factor as data is updated. For example, if it is presenting declinations in order of amount of the attempted transaction (from highest amount to lowest) then as new transaction declinations come in, the declination generation system 320 may insert them into the list of declinations at a location within the list that is based on the amount of the attempted transaction. In some embodiments, the GUI may include interactive elements (e.g., buttons or other inputs) that allow a user to specify that the declination data be arranged by a selected feature (e.g., by amount, by merchant, by virtual card number, etc.).

In block 110, the declination generation system 320 may transmit the GUI to the user device 402 for display. For example, in some embodiments, user device 402 may be a smartphone running a mobile software application (e.g., a mobile banking application) that is configured to display the GUI within the mobile application. According to some embodiments, the GUI may be configured to dynamically update in near real-time as new declinations occur and the declination generation system 320 processes the declination data received from one or more payment systems/networks. The GUI may include user input elements (e.g., buttons, scroll bars, sliders, etc.) that allow the user to navigate and/or selectively re-order a list of declinations based on a desired feature (e.g., order the list based on amount of transaction vs. timestamp). According to some embodiments, the GUI may be configured to provided assisted remedies to certain declination issues. For example, if a user has set up an autopay for a particular bill using a particular virtual card number and the virtual card number is declined because it has expired, the declination generation system 320 may be configured to provide a near real-time notification to the user about the expiry declination via a mobile software application on the user device 402 and may be configured to prompt the user to automatically create a new virtual card number or update the previous virtual card number used for the autopay bill to prevent future declinations. In this way, the declination system 320 can proactively assist the user in remedying declination issues with one or more virtual card numbers.

In block 112, the declination generation system 320 may receive one or more new declinations associated with the account from a network. The network may be a payment processing network such as for example, TSYS, Visa, MasterCard, AmericanExpress or any other such payment processing network. According to some embodiments, generation system 408 may be incorporated as part of a payment processing system/network or may otherwise be in communication with one or more payment processing systems/networks such that when a purchase is attempted using, for example, a virtual card number associated with the user's account, and the attempted transaction is declined by the payment processing system, then the generation system 408 may receive information about the attempted transaction (e.g., account number, merchant, amount, declination code, etc.) from the payment processing system/network. As that information is received, the generation system 408 can identify which user's account is associated with an attempted transaction and post information associated with a received declination to a declination statement associated with the proper user's account.

In block 114, the declination generation system 320 may modify the GUI to further comprise the one or more new declinations in response to receiving one or more new declinations associated with the account. As described above, in some embodiments, the declination generation system 320 may dynamically update a declination statement displayed by the GUI to include new declinations as they occur.

According to some embodiments, the declination generation system 320 may further be configured to generate an account number hash and a card number hash, associate the one or more declinations and the one or more new declinations with the account number hash and the card number hash, and cache the one or more declinations and the one or more new declinations in a database, such as database 416. Thus, in some embodiments, the declination generation system 320 may maintain a database of declinations where each declination is associated with an account number hash and a card number hash. As will be appreciated by those of skill in the art, creating and storing hash values of the account and card numbers can provide an extra layer of security to protect the account numbers.

In some embodiments, generating the declination statement may include sending a request to an application programming interface (API) to access the database and receiving a response comprising the one or more declinations and the one or more new declinations cached in the database. For example, if the declination generation system 320 is going to generate a declination statement for account number “1111-2222-3333-4444” and/or associated card number “1234-1234-1234-1234”, then the declination generation system 320 may send a request to an API to receive all declination information associated with the specified account and/or card numbers. The API may receive the specified account and/or card number and perform a look-up of the corresponding entries in the database (after accounting for hashing) and return those entries to the declination generation system 320. Based on the returned values, the declination generation system 320 may generate a declination statement that lists all of the declinations associated with the specified account number and/or card number.

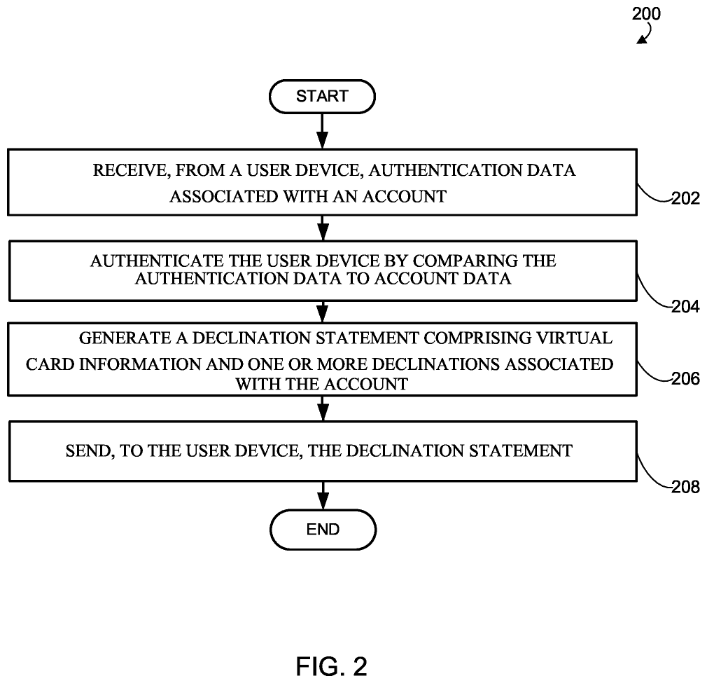

FIG. 2 is a flow diagram illustrating an exemplary method 200 for dynamic declination generation, in accordance with certain embodiments of the disclosed technology. The steps of method 200 may be performed by one or more components of the system 400 (e.g., declination generation system 320 or web server 410 of generation system 408 or user device 402), as described in more detail with respect to FIGS. 3 and 4.

Method 200 of FIG. 2 is similar to method 100 of FIG. 1, except that method 200 may not include blocks 108, 110, 112 and 114 of method 100. The descriptions of blocks 202, 204, and 206 in method 200 are similar to the respective descriptions of blocks 102, 104 and 106 of method 100 and are not repeated herein for brevity. However, additional blocks 208 is also described below.

In block 202, the declination generation system 320 may receive authentication data associated with an account from a user device, in a manner similar to that described above with respect to block 102.

In block 204, the declination generation system 320 may authenticate the user device by comparing the authentication data to account data in a manner similar to that described above with respect to block 104.

In block 206, the declination generation system 320 may generate a declination statement comprising virtual card information and one or more declinations associated with the account in a manner similar to that described above with respect to block 106. According to some embodiments, the one or more declinations may include restriction details, a declination code and/or a declination explanation. According to some embodiments, the one or more declinations may include one or more fraud declinations. A fraud declination may be a declination having a declination code that is indicative of a fraudulent transaction. For example, if a card has been reported as stolen any future transactions associated with the card may be declined as fraudulent and/or if a fraud detection system of the issuer determines that a transaction is suspicious and may be fraudulent for some reason (e.g., the card is being used in a geographically anomalous region than what is typical for the user) then the transaction may be declined as a fraudulent transaction. According to some embodiments, the declination statement may list the one or more fraud declinations before any remaining declinations. For example, a dynamic GUI that displays the declination statement may dynamically order a list of declinations such that all transactions that were declined because of suspected fraud may be listed first. In this way, the dynamic GUI may allow a user to quickly see which transactions and/or which virtual card numbers appear to have been compromised. According to some embodiments, if a particular virtual card number has had more than a specified threshold number of declinations (e.g., one, two or some other specified number) associated with potential fraud, then the declination generation system 320 may automatically cause some mitigating action to be taken. For example, according to some embodiments, the declination generation system 320 may notify the user in near real-time that a transaction has been declined due to suspected fraud. The notification may be provided via a mobile application running on the user device 402 and may identify the account number and/or virtual card number that was declined.

In block 208, the declination generation system 320 may send the declination statement to the user device.

According to some embodiments, the declination generation system 320 of method 200 may be further configured to generate a graphical user interface (GUI) comprising the declination statement and transmit the GUI to the user device for display in a manner similar to that described previously above.

According to some embodiments, the declination generation system 320 of method 200 may be further configured to receive one or more new declinations associated with the account from a network and modify the GUI to further comprise the one or more new declinations in response to receiving one or more new declinations associated with the account.

According to some embodiments, the declination generation system 320 of method 200 may be further configured to generate an account number hash and a card number hash, associate the one or more declinations and the one or more new declinations with the account number hash and the card number hash and cache the one or more declinations and the one or more new declinations in a database. In some embodiments, generating the declination statement may include sending a request to an application programming interface (API) to access the database and receiving a response comprising the one or more declinations and the one or more new declinations cached in the database.

FIG. 3 is a block diagram of an example declination generation system 320 used to generate a declination statement and GUI for presenting the declination statement according to an example implementation of the disclosed technology. According to some embodiments, the user device 402 and web server 410, as depicted in FIG. 4 and described below, may have a similar structure and components that are similar to those described with respect to declination generation system 320 shown in FIG. 3. As shown, the declination generation system 320 may include a processor 310, an input/output (I/O) device 370, a memory 330 containing an operating system (OS) 340 and a program 350. In certain example implementations, the declination generation system 320 may be a single server or may be configured as a distributed computer system including multiple servers or computers that interoperate to perform one or more of the processes and functionalities associated with the disclosed embodiments. In some embodiments declination generation system 320 may be one or more servers from a serverless or scaling server system. In some embodiments, the declination generation system 320 may further include a peripheral interface, a transceiver, a mobile network interface in communication with the processor 310, a bus configured to facilitate communication between the various components of the declination generation system 320, and a power source configured to power one or more components of the declination generation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the declination generation system 320 may include one or more storage devices configured to store information used by the processor 310 (or other components) to perform certain functions related to the disclosed embodiments. In one example, the declination generation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The declination generation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the declination generation system 320 may include the memory 330 that may include one or more programs 350 to perform one or more functions of the disclosed embodiments. For example, in some embodiments, the declination generation system 320 may additionally manage dialogue and/or other interactions with the customer via a program 350.

The processor 310 may execute one or more programs 350 located remotely from the declination generation system 320. For example, the declination generation system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a declination generation system database 360 for storing related data to enable the declination generation system 320 to perform one or more of the processes and functionalities associated with the disclosed embodiments.

The declination generation system database 360 may include stored data relating to accounts such as user information (e.g., name, address, username, password, etc.), account numbers (e.g., primary account number the represents a user's credit card number), associated virtual card numbers and rules, historical account information (e.g., balances, charges, etc.), and declination information that may represent instances where a card or account was declined and associated information (e.g., time, location/merchant, card number, transaction amount, declination code and/or reason for declination, etc.). In some embodiments, the declination generation system database 360 may store account statements that may be also typically mailed or electronically delivered to a user on a monthly basis. According to some embodiments, the account statements may be stored as an image file type (e.g., PDF) that may allow for the presence of a QR code to be displayed or printed on the statement. According to some embodiments, the functions provided by the declination generation system database 360 may also be provided by a database that is external to the declination generation system 320, such as the database 416 as shown in FIG. 4.

The declination generation system 320 may also be communicatively connected to one or more memory devices (e.g., databases) locally or through a network. The remote memory devices may be configured to store information and may be accessed and/or managed by the declination generation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The declination generation system 320 may also include one or more I/O devices 370 that may comprise one or more interfaces for receiving signals or input from devices and providing signals or output to one or more devices that allow data to be received and/or transmitted by the declination generation system 320. For example, the declination generation system 320 may include interface components, which may provide interfaces to one or more input devices, such as one or more keyboards, mouse devices, touch screens, track pads, trackballs, scroll wheels, digital cameras, microphones, sensors, and the like, that enable the declination generation system 320 to receive data from a user (such as, for example, via the user device 402).

In examples of the disclosed technology, the declination generation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The declination generation system 320 may be configured to interact with more or more payment processing systems to collect data about transactions and attempted transactions using account numbers (e.g., credit card numbers) and virtual account numbers (e.g., a tokenized credit card number). In some embodiments, the declination generation system 320 may share information with a payment processing system (e.g., TSYS) in real time via a POST-AUTH stream, sharing the token-requestor-id (identification of virtual card number channel), the token-reference-id (associated with virtual card number identification) and declination codes, which can be used by the declination generation system 320 to generate and associate a transaction declination history for a virtual card number. According to some embodiments, the declination generation system 320 may be configured to receive such transaction data in near real-time, or within a relatively short time frame following an event, such as seconds or minutes. Thus, for example, if there has been an attempt to use a virtual card number to make a purchase at a merchant website and the attempted purchase is declined by the payment processing system, the declination generation system 320 may be configured to receive information about the declined transaction (e.g., card number, amount, merchant ID, reason for declination, etc.) immediately after the declination has occurred. The received declination information can then by incorporated into a declination statement by the declination generation system 320. In some embodiments, the declination generation system 320 can be configured to push real-time notifications to a user device 402 upon the occurrence of a declination. For example, in some embodiments, if a user's virtual card number has been declined, in addition to adding the declination information to a declination statement, the declination generation system 320 may also send an immediate notification to the user to notify them that the declination has occurred. Such immediate notifications may be sent via a push notification to a mobile application installed on a user device 402, via text message or automated voice message to a phone number associated with a user, via email to a user, via an instant message to a user or via any other such form of communication as may be known.

According to some embodiments, the declination generation system 320 may be configured to generate a unique QR code for each user account that encodes the identification of the user account in the code and that can be printed/displayed on an account statement that corresponds to the user's account. Thus, in some embodiments, upon receiving an account statement (e.g., in the mail) a user may scan the QR code on their printed monthly account statement using user device 402 and the user device 402 may decode the QR code to provide access to the user's account (e.g., via a mobile application running on the phone or via a web browser that launches in response to scanning the QR code), where the user may view the declination statement or may be presented with a GUI that may dynamically present the declination statement. In this way, a user can easily and quickly access their declination statement to view information such as, for example, which cards/accounts have had declinations, when they occurred, at what merchant they occurred, what the amount of the transaction was, and what the reason for the declination was. The GUI may be configured such that a user may selectively reorder a list of declinations based on a selection of features such as date, merchant, transaction amount, card identification, number of declinations (e.g., over a selected time period), status of card (e.g., expired, frozen for security reasons, etc.), reason for declination (e.g., by declination code obtained from a payment processing system) or by the level of suspected fraud (e.g., list declinations that are associated with highest confidence of suspected fraudulent activity first). According to some embodiments, the declination generation system 320 may be configured to receive new declination information from one or more payment processing systems in near real-time and dynamically update the GUI with the new information as it comes in. Thus, for example, as a user is viewing the GUI, a new declination may be added to the list of declinations being viewed by the user in the appropriate place on the list according with the desired feature the list is being sorted by.

According to some embodiments, the declination generation system 320 may provide further interactive elements within the GUI that may allow the user to take one or more actions with respect to a declination or a card/account associated with a declination. For instance, in a case where a virtual card number was stored on a merchant website to be used for an automatic monthly payment, but the card was declined because it had expired, the GUI may be configured to allow the user to extend the virtual card number expiration date or generate a new virtual card number and upload it to the merchant website. In some embodiments, a mobile application running on the user device 402 (and/or web application hosted by web server 410) may store a list of virtual card numbers associated with the user's primary account and the rules that are associated with each virtual card number. For example, a first virtual card number may be restricted to use at a first merchant and a second virtual card number may be restricted to use at a second merchant. In some embodiments, if the first virtual card number is declined by the first merchant because it has expired, the GUI displaying the declination statement may include interactive elements that allow the user to create a replacement virtual card number for upload at the first merchant. In some embodiments, a mobile application running on the user device 402 may include an application programming interface (API) that is configured to allow it to interface and communicate with a merchant web system such that the user may be able to create a new virtual card number and have it uploaded to the merchant website for future use simply by interacting with elements of the GUI or other aspects of the mobile application. Thus, in such case, the declination generation system 320 may generate a GUI that may allow a user to quickly identify that a virtual card number has been declined due to expiration of the card and quickly rectify the problem by creating and uploading a new virtual card number to the merchant site.

According to some embodiments, if a virtual card number has been declined because it was used in an unauthorized fashion (e.g., it was used at a merchant that it was not authorized to be used at), the GUI may provide interactive features (e.g., buttons, drop down menus, check boxes, etc.) that may allow the user to cancel the virtual card number. In some embodiments, the GUI may provide interactive features that allow a user to change the rules associated with a selected virtual card number (VCN). For example, if a VCN was declined because it was only authorized to be used at a first merchant but there was a legitimate attempt to use the VCN at a second merchant by the user, interactive features of the GUI may allow the user to modify the rules associated with the VCN to, for example, allow the VCN to be used to make purchases at the second merchant. In the case where the user is attempting to make a purchase in real-time and the purchase is being declined in real-time, this functionality may be particularly helpful as the user may be able to pull up the dynamically displayed declination statement in the GUI, quickly locate the declination that may have information associated with the declination such as the VCN and merchant code, and may be enabled to select options to authorize the selected VCN with the merchant based on the merchant code listed in association with the declination. In some embodiments, the GUI may provide interactive features that allow a user to take other actions, such as delete/cancel a virtual card number (e.g., if a merchant is closing down), conditionally update the virtual card number controls (e.g., to increase the number of authorized uses a virtual card number is allowed to have or timeframe for which the virtual card number is authorized to be used) and/or unlocked a virtual card number if it has been locked.

While the declination generation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the declination generation system 320 may include a greater or lesser number of components than those illustrated.

FIG. 4 is a block diagram of an example system 400 that includes a user device 402 that may be used to view and interact with generation system 408, according to an example implementation of the disclosed technology. The components and arrangements shown in FIG. 4 are not intended to limit the disclosed embodiments as the components used to implement the disclosed processes and features may vary. As shown, generation system 408 may interact with a user device 402 via a network 406. In certain example implementations, the generation system 408 may include a local network 412, a declination generation system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the generation system 408. In some embodiments, the user device 402 may include or incorporate electronic communication devices for hearing or vision impaired users.

According to some embodiments, the user device 402 may include a digital camera for obtaining images and software for processing the images in certain ways. For example, in some embodiments, the user device 402 may be configured to obtain an image of a QR code and may include software to decode the QR code in order to, for example, generate a link to a website and/or account information encoded by the QR code. In some embodiments, the user device 402 may be configured to obtain one or more images (or other sensor data) of a user's face and software for performing facial recognition in order to authenticate the user.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the generation system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The generation system 408 may be associated with and optionally controlled by one or more entities such as a business, corporation, individual, partnership, or any other entity that provides one or more of goods, services, and consultations to individuals such as customers. In some embodiments, the generation system 408 may be controlled by a third party on behalf of another business, corporation, individual, partnership. The generation system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the declination generation system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

According to some embodiments, web server 410 may be configured to load a hosted website in response to a communication from user device 402. For example, in some embodiments, user device 402 may scan a QR code that embeds a link to a website and in response to scanning the QR code, the user device 402 may open a web browser or mobile application that establishes communication with web server 410 to render the website or provide data to the mobile application. According to some embodiments, the QR code may encode user account information such that when the user device 402 establishes communication with the web server 410, an identity of the user account is communicated to the web server 410. Thus, for example, in some embodiments, a user may scan a QR code on user device 402, which may cause the user device 402 to pull up a website or open a mobile application that is already prepopulated with the user's account number and/or login name based on the account information encoded in the QR code. According to some embodiments, the web server 410 may host a website that is configured to render a dynamic GUI and associated interactive elements as described herein.

The local network 412 may include any type of computer networking arrangement used to exchange data in a localized area, such as WiFi, Bluetooth™, Ethernet, and other suitable network connections that enable components of the generation system 408 to interact with one another and to connect to the network 406 for interacting with components in the system 400 environment. In some embodiments, the local network 412 may include an interface for communicating with or linking to the network 406. In other embodiments, certain components of the generation system 408 may communicate via the network 406, without a separate local network 406.

The generation system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access generation system 408 using the cloud computing environment. User device 402 may be able to access generation system 408 using specialized software. The cloud computing environment may eliminate the need to install specialized software on user device 402.

In accordance with certain example implementations of the disclosed technology, the generation system 408 may include one or more computer systems configured to compile data from a plurality of sources such as the declination generation system 320, web server 410, and/or the database 416. The declination generation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Although the preceding description describes various functions of a web server 410, a declination generation system 320, a database 416 and user device 402, in some embodiments, some or all of these functions may be carried out by a single computing device.

### EXAMPLE USE CASE

The following example use case describes an example of a typical user flow pattern. This section is intended solely for explanatory purposes and not in limitation.

In one example, a user may have a primary credit card from which they may have created three virtual card numbers (VCNs). In creating the VCNs, the user designated rules for each VCN that restricts its authorized use to a different online merchant, for example, a cable company, an online clothing retailer and an online department store, respectively. The user has uploaded and stored the first VCN to the web server of the cable company and has set it up to pay a monthly cable bill using the VCN. At some point, the VCN expires and the payment of the monthly cable bill is declined. The system (e.g., declination generation system 320) obtains data about the declined transaction from a payment processing system and adds it to a declination statement. In another instance, the user accidentally incorrectly uses the second VCN at the online department store and because this VCN was not authorized for use at the online department store the transaction is declined and similarly added to the declination statement. In another instance, the third VCN was compromised by a bad actor who attempted to use the VCN at an online sporting goods merchant, and use of the card at an unauthorized merchant similarly caused the transaction to be declined and the declination information be added to the declination statement. As each declination occurs, the system dynamically updates a GUI that displays the declination statement to the user via the user's smartphone (e.g., user device 402) via a mobile application running on the smartphone, such as a mobile banking application. The GUI displays the declination information relating to the attempted transaction, such as one or more of time, date, location, merchant, transaction amount, VCN number, primary account number, declination code, reason for the declination and an indication of a confidence level that the transaction was fraudulent. The GUI may include interactive elements that allow the user to sort the declinations by any of these features. The GUI may also include interactive elements that allow the user to take one or more actions in relation to the declinations. For example, in the case of the first VCN that has expired, the GUI may inform the use that their recurring cable bill charge was declined because the VCN had expired and provide interactive elements that allow the user to quickly generate a new VCN and replace the expired VCN with the new VCN in the cable company's system (e.g., via an API that is set up to interact with the cable company's system). In the case of the second and third VCNs, the GUI may inform the user that the transactions associated with the VCNs were declined because they were used at unauthorized merchants and may provide interactive elements to allow the user to take actions to address these issues. For example, in the case of the second VCN, the GUI may include interactive elements that may allow the user to modify the rules associated with the VCN to authorize the second VCN to be used at the online department store in the future if the user desires to be allowed to use this VCN in this manner in the future. In the case of the third VCN, the GUI may include interactive elements that allow the user to confirm that the attempted transaction using this VCN was fraudulent and cancel the VCN. In this way, the system can provide the user with near real-time information about VCN declinations via a dynamic GUI to gain an understanding of when and why VCN transactions were declined, as well as providing interactive elements in the GUI that allow the user to actively mitigate or manage these issues as they arise.

In another example, a user may receive a monthly credit card statement in the mail and the credit card statement may include a QR code that when scanned by the user's smartphone, causes a link to a website to open that is prepopulated with some user account information that was encoded in the QR code (e.g., account number or username). In some cases, the user may be able to gain access to their account following the activation of the decoded link simply by having their smartphone authenticate their identity, by for example, performing a facial recognition scan of the user to confirm that the user's identity is the same that is associated with the account information encoded by the QR code. Alternatively, the user could be authenticated by responding to a prompt to provide the last 4 digits of the account number or the card verification value (CVV) of the associated card. For example, the system could store a hash value of the CVV of the card and compare it to a hash of the input CVV and authenticate the user upon determining that the values match. Upon being authenticated, the user may access content on the linked website that includes a declination statement that may be presented in a dynamic GUI. For example, the GUI may present declination information that can be searched and sorted by the user and may include interactive elements that allow a user to take actions with respect to declined VCNs as described above. In this way, the system can provide the user with secure, quick access to declination information and actionable items that were not previously readily available.

In some examples, disclosed systems or methods may involve one or more of the following clauses:

Clause 1: A system comprising: one or more processors; and memory in communication with the one or more processors and storing instructions that are configured to cause the dynamic declination generation system to: receive, from a user device, authentication data associated with an account; authenticate the user device by comparing the authentication data to account data; generate a declination statement comprising virtual card information and one or more declinations associated with the account; generate a graphical user interface (GUI) comprising the declination statement; transmit the GUI to the user device for display; receive, from a network, one or more new declinations associated with the account; and responsive to receiving one or more new declinations associated with the account, modify the GUI to further comprise the one or more new declinations.

Clause 2: The system of clause 1, wherein the virtual card information comprises an account number, a card number, and a status of the account.

Clause 3: The system of clause 1, wherein the one or more declinations comprise of restriction details, a declination code and a declination explanation.

Clause 4: The system of clause 1, wherein the memory stores further instructions that are configured to cause the system to: generate an account number hash and a card number hash; associate the one or more declinations and the one or more new declinations with the account number hash and the card number hash; and cache the one or more declinations and the one or more new declinations in a database.

Clause 5: The system of clause 4, wherein generating the declination statement further comprises: sending a request to an application programming interface (API) to access the database; and receiving a response comprising the one or more declinations and the one or more new declinations cached in the database.

Clause 6: The system of clause 1, wherein the authentication data associated with the account is received from the user device via a quick response code.

Clause 7: A system comprising: one or more processors; and memory in communication with the one or more processors and storing instructions that are configured to cause the dynamic declination generation system to: generate a declination statement comprising virtual card information and one or more declinations associated with an account; generate a graphical user interface (GUI) comprising the declination statement; transmit the GUI to a user device for display; receive, from a network, one or more new declinations associated with the account; and responsive to receiving one or more new declinations associated with the account, modify the GUI to further comprise the one or more new declinations.

Clause 8: The system of clause 7, wherein the memory stores further instructions that are configured to cause the system to: receive, from a user device, authentication data associated with an account; and authenticate the user device by comparing the authentication data to account data.

Clause 9: The system of clause 8, wherein the authentication data associated with the account is received from the user device via a quick response code.

Clause 10: The system of clause 7, wherein the virtual card information comprises an account number, a card number, and a status of the account.

Clause 11: The system of clause 7, wherein the one or more declinations comprise of restriction details, a declination code and a declination explanation.

Clause 12: The system of clause 7, wherein the memory stores further instructions that are configured to cause the system to: generate an account number hash and a card number hash; associate the one or more declinations and the one or more new declinations with the account number hash and the card number hash; and cache the one or more declinations and the one or more new declinations in a database.

Clause 13: The system of clause 12, wherein generating the declination statement further comprises: sending a request to an application programming interface (API) to access the database; and receiving a response comprising the one or more declinations and the one or more new declinations cached in the database.

Clause 14: A system comprising: one or more processors; and memory in communication with the one or more processors and storing instructions that are configured to cause the dynamic declination generation system to: receive, from a user device, authentication data associated with an account; authenticate the user device by comparing the authentication data to account data; generate a declination statement comprising virtual card information and one or more declinations associated with the account; and send, to the user device, the declination statement.

Clause 15: The system of clause 14, wherein the memory stores further instructions that are configured to cause the system to: generate a graphical user interface (GUI) comprising the declination statement; and transmit the GUI to the user device for display.

Clause 16: The system of clause 15, wherein the memory stores further instructions that are configured to cause the system to: receive, from a network, one or more new declinations associated with the account; and responsive to receiving one or more new declinations associated with the account, modify the GUI to further comprise the one or more new declinations.

Clause 17: The system of clause 16, wherein the memory stores further instructions that are configured to cause the system to: generate an account number hash and a card number hash; associate the one or more declinations and the one or more new declinations with the account number hash and the card number hash; and cache the one or more declinations and the one or more new declinations in a database.

Clause 18: The system of clause 17,wherein generating the declination statement further comprises: sending a request to an application programming interface (API) to access the database; and receiving a response comprising the one or more declinations and the one or more new declinations cached in the database.

Clause 19: The system of clause 14, wherein the one or more declinations comprise of restriction details, a declination code and a declination explanation.

Clause 20: The system of clause 14, wherein the one or more declinations comprise one or more fraud declinations and wherein the declination statement lists the one or more fraud declinations before any remaining declinations.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component.” “module.” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments.” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third.” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
memory in communication with the one or more processors and storing instructions that are configured to cause the dynamic declination generation system to:
receive, from a user device, authentication data associated with an account;
authenticate the user device by comparing the authentication data to account data;
generate a declination statement comprising virtual card information and one or more declinations associated with the account;
generate a graphical user interface (GUI) comprising the declination statement;
transmit the GUI to the user device for display;
receive, from a network, one or more new declinations associated with the account; and
responsive to receiving one or more new declinations associated with the account, modify the GUI to further comprise the one or more new declinations.

2. The system of claim 1, wherein the virtual card information comprises an account number, a card number, and a status of the account.

3. The system of claim 1, wherein the one or more declinations comprise of restriction details, a declination code and a declination explanation.

4. The system of claim 1, wherein the memory stores further instructions that are configured to cause the system to:
generate an account number hash and a card number hash;
associate the one or more declinations and the one or more new declinations with the account number hash and the card number hash; and
cache the one or more declinations and the one or more new declinations in a database.

5. The system of claim 4, wherein generating the declination statement further comprises:
sending a request to an application programming interface (API) to access the database; and
receiving a response comprising the one or more declinations and the one or more new declinations cached in the database.

6. The system of claim 1, wherein the authentication data associated with the account is received from the user device via a quick response code.

7. A system comprising:
one or more processors; and
memory in communication with the one or more processors and storing instructions that are configured to cause the dynamic declination generation system to:
generate a declination statement comprising virtual card information and one or more declinations associated with an account;
generate a graphical user interface (GUI) comprising the declination statement;
transmit the GUI to a user device for display;
receive, from a network, one or more new declinations associated with the account; and
responsive to receiving one or more new declinations associated with the account, modify the GUI to further comprise the one or more new declinations.

8. The system of claim 7, wherein the memory stores further instructions that are configured to cause the system to:
receive, from a user device, authentication data associated with an account; and
authenticate the user device by comparing the authentication data to account data.

9. The system of claim 8, wherein the authentication data associated with the account is received from the user device via a quick response code.

10. The system of claim 7, wherein the virtual card information comprises an account number, a card number, and a status of the account.

11. The system of claim 7, wherein the one or more declinations comprise of restriction details, a declination code and a declination explanation.

12. The system of claim 7, wherein the memory stores further instructions that are configured to cause the system to:
generate an account number hash and a card number hash;
associate the one or more declinations and the one or more new declinations with the account number hash and the card number hash; and
cache the one or more declinations and the one or more new declinations in a database.

13. The system of claim 12, wherein generating the declination statement further comprises:
sending a request to an application programming interface (API) to access the database; and
receiving a response comprising the one or more declinations and the one or more new declinations cached in the database.

14. A system comprising:
one or more processors; and
memory in communication with the one or more processors and storing instructions that are configured to cause the dynamic declination generation system to:
receive, from a user device, authentication data associated with an account;
authenticate the user device by comparing the authentication data to account data;
generate a declination statement comprising virtual card information and one or more declinations associated with the account; and
send, to the user device, the declination statement.

15. The system of claim 14, wherein the memory stores further instructions that are configured to cause the system to:
generate a graphical user interface (GUI) comprising the declination statement; and
transmit the GUI to the user device for display.

16. The system of claim 15, wherein the memory stores further instructions that are configured to cause the system to:
receive, from a network, one or more new declinations associated with the account; and
responsive to receiving one or more new declinations associated with the account, modify the GUI to further comprise the one or more new declinations.

17. The system of claim 16, wherein the memory stores further instructions that are configured to cause the system to:
generate an account number hash and a card number hash;
associate the one or more declinations and the one or more new declinations with the account number hash and the card number hash; and
cache the one or more declinations and the one or more new declinations in a database.

18. The system of claim 17, wherein generating the declination statement further comprises:
sending a request to an application programming interface (API) to access the database; and
receiving a response comprising the one or more declinations and the one or more new declinations cached in the database.

19. The system of claim 14, wherein the one or more declinations comprise of restriction details, a declination code and a declination explanation.

20. The system of claim 14, wherein the one or more declinations comprise one or more fraud declinations and wherein the declination statement lists the one or more fraud declinations before any remaining declinations.
